(19) United States
(12) Patent Application Publication
(10) Pub. No.: US 2012/0102831 A1
(43) Pub. Date: May 3, 2012

(54) A METHOD FOR GERMINATION OF HALOXYLON PERSICUM

(75) Inventor: Nasser Saleh Ali Al-Khalifah, Riyadh (SA)

(73) Assignee: King Abdul Aziz City for Science and Technology, Riyadh (SA)

(21) Appl. No.: 12/938,565

(22) Filed: Nov. 3, 2010

(51) Int. Cl. A01G 31/00

(52) U.S. Cl. 47/61

(57) ABSTRACT

A method for in vitro germination of seeds of Haloxylon persicum i.e., Ghada plant is disclosed. The method includes soaking sterilized seeds in sterile water for a predetermined time. Soaking facilitates development of germinating embryos from the sterilized seeds. Thereafter, the germinating embryos are isolated from the sterilized seeds. Subsequently, the isolated germinating embryos are cultured in vitro in a culture medium to obtain shoots of the Ghada plant. The method may be utilized for in vitro mass germination of the Ghada plant.

### FIELD OF THE INVENTION

The invention generally relates to germination of seeds of desert plants. More specifically, the invention relates to a method for germinating seeds of Haloxylon persicum.

### BACKGROUND OF THE INVENTION

Haloxylon persicum is commonly known as Ghada in Arabic and white saxaul in English. The Ghada plant is a shrub belonging to the family Chenopodiaceae. Ghada plant is generally found in deserts of Asia, including Palestine, Jordan, Egypt, Sinai, South Iraq, Saudi Arabia, Iran, Oman, UAE, Afghanistan, Baluchistan and China. The wood of a Ghada plant has a high calorific value and is used as firewood and for making charcoal. Exploitation of the Ghada plants as fodder and firewood is leading to decrease in population of the Ghada plants in deserts. This decrease in population of the Ghada plants may further be attributed to extreme environmental conditions in the deserts. For example, during sand storms the seeds of the Ghada plants become dormant as the seeds get buried deep under sand. As a result, the germination of the seeds is suppressed. In addition, the survival rate of the Ghada plants is low as compared to other plants in the desert due to higher seed mortality and poor regeneration of the Ghada seeds in natural conditions. Seed mortality and poor regeneration of the Ghada seeds may also be attributed to lack of endosperm in the Ghada seeds.

Therefore, efforts have been made in the art for growing the Ghada plants under controlled conditions using various plant tissue culture techniques to improve survival rate of the Ghada seeds. Plant tissue culture techniques for growing the Ghada plants include micro-propagation, axillary bud proliferation and seed germination. However, till date these techniques have not been successful in enhancing the survival rates of the Ghada seeds owing to certain inherent attributes associated with these techniques. For example, various sterilants used for sterilizing the Ghada seeds may not yield favorable results and may even result in death of the Ghada seeds. Survival rate of the Ghada seeds during seed germination using tissue culture is low due to unavailability of adequate moisture in the germination medium. Thus, mass production of the Ghada plants using tissue culture is still a challenge.

Therefore, there is a need for an improved seed germination method for the Ghada seeds that is suitable for mass production of the Ghada plants.

### BRIEF DESCRIPTION OF THE FIGURES

FIG. 1 illustrates a flow chart of a method for in vitro germination of one or more seeds of Ghada plant in accordance with an embodiment of the invention.

FIG. 2 illustrates a flowchart of a method for in vitro germination of one or more seeds of Ghada plant in accordance with another embodiment of the invention.

### DETAILED DESCRIPTION OF THE INVENTION

In this document, relational terms such as first and second, and the like may be used solely to distinguish one entity from another entity without necessarily requiring or implying any actual such relationship or order between such entities.

Various embodiments of the invention provide a method for in vitro germination of one or more seeds of Ghada plant. The method includes soaking one or more sterilized seeds in sterile water for a predetermined time. Soaking facilitates development of one or more germinating embryos from the one or more sterilized seeds. Thereafter, the one or more germinating embryos are isolated from the one or more sterilized seeds. Subsequently, the one or more isolated germinating embryos are cultured in vitro in a culture medium to obtain one or more shoots of the Ghada plant.

“Ghada” is a common name for plant Haloxylon persicum. Haloxylon persicum is a white saxaul tree belonging to the family Chenopodiaceae. Haloxylon persicum is generally found in deserts of Asia, including Palestine, Jordan, Egypt, Sinai, South Iraq, Saudi Arabia, Iran, Oman, UAE, Afghanistan, Baluchistan, and China. Examples of Haloxylon persicum include, but are not limited to, Haloxylon persicum, Bunge.

In accordance with various embodiments, one or more flowers or one or more fruits of Haloxylon persicum may be collected from a natural population of Haloxylon persicum during an appropriate season. For example, the one or more flowers may be collected during month of November that is a flowering season for Haloxylon persicum in Saudi Arabia. The one or more flowers or the one or more fruits may be then crushed by hands to remove perianth lobes of the one or more flowers or the one or more fruits. The perianth lobes are removed to obtain one or more seeds of Haloxylon persicum. Alternatively, the perianth lobes may be removed using any suitable method known in the art. In an embodiment, the one or more seeds are obtained by removing the perianth lobes of the one or more flowers using a sterilized scalpel. The one or more seeds obtained may include one or more matured seeds.

The one or more seeds are then sterilized in order to avoid contamination of the one or more seeds. The sterilization of the one or more seeds may be achieved, for example, but not limited to, by washing the one or more seeds with sterilized water for a predetermined time to obtain one or more sterilized seeds. The predetermined time for sterilization may range from half an hour to two hours. Although sterilization of the one or more seeds with sterilized water has been explained as an example, the one or more seeds may be sterilized using other sterilization techniques that do not affect the characteristics of the one or more seeds, without departing from the scope of the invention. For example, the one or more seeds may be sterilized using sterilants, such as, mercuric chloride and chemical sterilants that do not affect the characteristics of the one or more seeds. Alternatively, the one or more seeds may be sterilized using UV radiation.

In an embodiment, the one or more seeds are washed in one or more laboratory tubes. The one or more laboratory tubes may be covered with a sieve or any other appropriate cover to prevent the one or more seeds from running off during washing. The one or more seeds may be washed with running sterile water for the predetermined time. As a result, testas of the one or more sterilized seeds softens. The softened testas enable the one or more sterilized seeds in imbibing water more efficiently thereby expediting the process of germination of the one or more sterilized seeds.

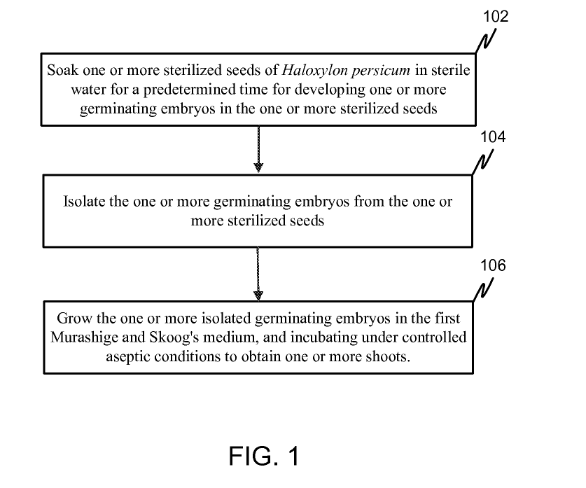

FIG. 1 illustrates a flow chart of a method for in vitro germination of one or more seeds of Ghada plant in accordance with an embodiment of the invention. The method includes, at step 102, soaking one or more sterilized seeds in sterile water for a predetermined time. Soaking facilitates development of one or more germinating embryos from the one or more sterilized seeds. Thereafter, the one or more germinating embryos are isolated from the one or more sterilized seeds at step 104. Subsequently, the one or more isolated germinating embryos are cultured in vitro in a culture medium to obtain one or more shoots of the Ghada plant at step 106.

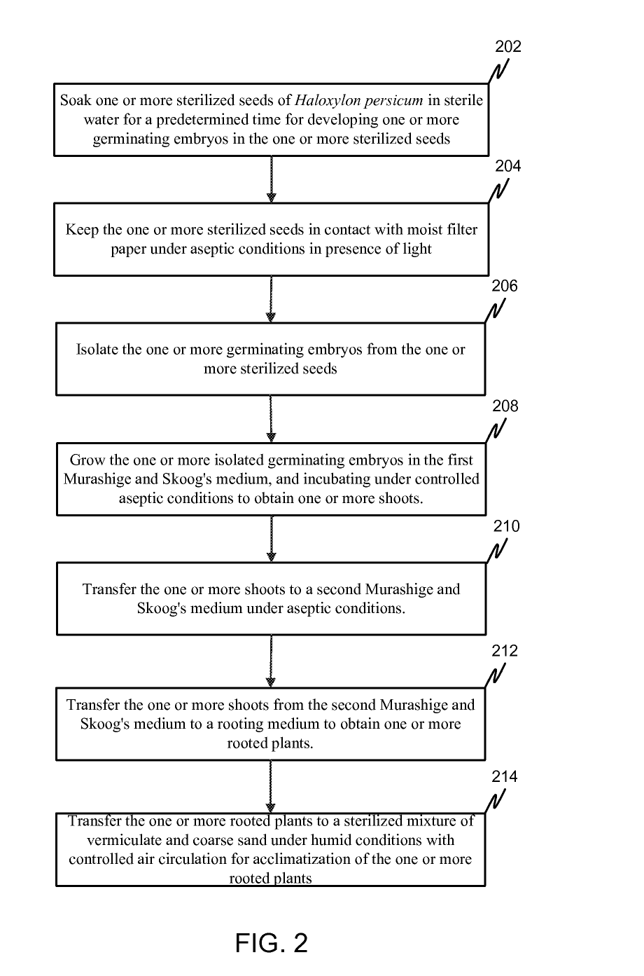

FIG. 2 illustrates a flowchart of a method for in vitro germination of the one or more seeds of Ghada plant in accordance with another embodiment of the invention. At step 202 the one or more sterilized seeds are soaked in sterile water, such as, sterile distilled water for a predetermined time. The predetermined time for soaking may range from one hour to six hours. Soaking enables the one or more sterilized seeds to imbibe water for germinating. For example, the one or more sterilized seeds are soaked in sterile distilled water for about four hours. Soaking the one or more sterilized seeds in sterile distilled water for the predetermined time produces one or more germinating embryos in the one or more sterilized seeds.

As an alternative to soaking, the one or more sterilized seeds at step 204 may be kept in contact with one or more of, but not limited to, a moist filter paper or a moist cotton pad for a predetermined contact time. The predetermined contact time may range from one hour to six hours. While keeping the one or more sterilized seeds in contact with the moist filter paper, the moist filter paper may be covered in order to avoid contamination of the one or more sterilized seeds. Further, the one or more sterilized seeds are kept under aseptic condition in presence of light during the predetermined contact time.

As the one or more sterilized seeds are in contact with the moist filter paper for the predetermined contact time, adequate moisture may be provided to the one or more seeds for germination. Further, the presence of light and the aseptic conditions also provide favorable conditions for germination of the one or more sterilized seeds. Thus, one or more germinating embryos are produced from the one or more sterilized seeds.

In an embodiment, the one or more sterilized seeds are soaked in sterile distilled water for the predetermined time. Subsequently, the one or more sterilized seeds are kept in contact with the moist filter paper for the predetermined contact time to produce the one or more germinating embryos.

The one or more sterilized seeds with the one or more germinating embryos thus obtained, lack endosperms. This may result in poor regeneration of the one or more sterilized seeds. Therefore, upon development of the one or more germinating embryos, at step 206 the one or more germinating embryos are isolated from the one or more sterilized seeds. The one or more germinating embryos may be isolated using suitable techniques known in the art. For example, the one or more germinating embryos may be dissected from pericarps of the one or more sterilized seeds by removing testas of the one or more sterilized seeds. The testas of the one or more sterilized seeds may hinder the uptake of nutrients from a culture medium. Further, the testas of the one or more sterilized seeds may contain microorganisms that may adhere to the one or more germinating embryos and contaminate the culture medium. Thus, isolating the one or more germinating embryos from the one or more sterilized seeds facilitates proper regeneration of the one or more sterilized seeds.

In order to ensure sterility of the one or more isolated germinating embryos, the one or more isolated germinating embryos may be soaked in 0.05 to 0.15% mercuric chloride (HgCl₂) solution for 1 to 5 minutes. Thereafter, the one or more isolated germinating embryos are washed two to four times with sterilized distilled water to remove traces of mercuric chloride. Thus, soaking the one or more isolated germinating embryos in mercuric chloride eliminates the presence of microorganisms on the one or more isolated germinating embryos.

Subsequently the one or more isolated germinating embryos may be cultured in a culture medium. Examples of the culture medium may include, but are not limited to a first modified Murashige and Skoog's (MS) medium. The first modified MS medium may include a MS medium supplemented with one or more supplements. The one or more supplements may be, for example, but are not limited to sucrose, Kinetin (6-furfurylaminopurine), Benzyladenine (BAP) and Gibberellic acid (GA3). Concentrations of the one or more supplements may range from 2.7 to 3.3% (27 g/l to 33 g/l) for sucrose, 2 to 4 mg/l for Kinetin, 1 to 3 mg/l for BAP and 0.1 to 1.5 mg/l for GA3. Alternatively, the first modified MS medium may include supplements which exhibit similar properties as the one or more of sucrose, Kinetin, BAP and GA3.

At step 208, the one or more isolated germinating embryos are grown or cultured in the first modified MS medium under controlled aseptic conditions for a time ranging from one week to four weeks. The culture may be incubated for a photo-period ranging from 15 to 17 hours with light intensity ranging from 3000 to 5000 lux daily at a temperature ranging from 23 to 27° C. Culturing the one or more isolated germinating embryos in the first modified MS medium under controlled aseptic conditions leads to development of one or more shoots from the one or more isolated germinating embryos.

At step 210, the one or more shoots may be sub-cultured at intervals of one month to two months by transferring the one or more shoots to a second modified MS medium under controlled aseptic conditions. The second modified MS medium may include a MS medium supplemented with sucrose, Kinetin, BAP and GA3. Concentrations of the one or more supplements may range from 2.7 to 3.3% for sucrose, 2 to 4 mg/l for Kinetin, 1 to 3 mg/l for BAP and 0.1 to 1.5 mg/l for GA3. Alternatively, the second modified MS medium may include supplements which exhibit similar properties as the one or more of sucrose, Kinetin, BAP and GA3. The sub-culture may be incubated for a photo-period ranging from 15 to 17 hours with light intensity ranging from 3000 to 5000 lux daily at a temperature ranging from 23 to 27° C. Sub-culturing the one or more shoots in the second modified MS medium under controlled aseptic conditions leads to development of one or more long shoots from the one or more shoots. The one or more long shoots are morphologically more developed as compared to the one or more shoots. For example, the one or more long shoots may have a length ranging from 2 to 8 cm. Further, one or more shots that do not develop into the one or more long shoots may be transferred to the second modified MS medium for further growth and development into the one or more long shoots.

The one or more long shoots are subsequently transferred at step 212 to a rooting medium and cultured to obtain one or more rooted plants. The rooting medium may include a MS medium supplemented with Indole-3-butyric acid (IBA). Concentration of IBA in the rooting medium may range from 0.5 to 1.5 mg/l. Alternatively, the rooting medium may include supplements which exhibit similar properties as that of IBA. In addition, the strength of the MS medium in the rooting medium may be lower than strength of the MS medium present in the first modified MS medium. For example, the strength of the rooting medium may be half as compared with the strength of the MS medium present in the first modified MS medium. In an embodiment, the one or more long shoots may also be obtained by culturing the one or more shoots in the first modified MS medium. Thereafter, the one or more long shoots may be directly transferred to a rooting medium to develop into one or more rooted plants, without a need for sub-culturing.

These one or more rooted plants are then subjected to an acclimatization process at step 214 for acclimatization of the one or more rooted plants to a natural habitat. The acclimatization process may include transferring the one or more rooted plants to a sterilized mixture of various soils. Example of the sterilized mixture of various soils may include, but are not limited to, a mixture containing vermiculate and coarse sand. The ratio of the vermiculate and coarse sand may be, for example, but not limited to, 1:1. The one or more rooted plants in the sterilized mixture of vermiculate and coarse sand may be kept under humid conditions for a predetermined acclimatization time. The predetermined acclimatization time may range from two to five days. In addition, air circulation may be permitted gradually for a duration ranging from one to three weeks prior to transferring the one or more rooted plants to a greenhouse. The one or more rooted plants thus obtained may then grow in the green house to develop into one or more matured plants.

In an embodiment, the one or more seeds of Haloxylon persicum are collected from natural populations of the one or more flowers of Haloxylon persicum during the flowering season, such as, early November in Saudi Arabia. The one or more seeds are obtained by removing the perianth lobes of the one or more flowers using a sterilized scalpel. Thereafter, the one or more seeds are sterilized by washing the one or more seeds with sterile running water for less than an hour in a sterile test tube covered with a sieve. Subsequently, the one or more sterilized seeds are soaked in sterilized distilled water for two to four hours in presence of light under aseptic conditions. Thereafter, the one or more sterilized seeds are spread on a moist filter paper and covered using petri plates to avoid contamination of the one or more sterilized seeds. The one or more sterilized seeds are kept in contact with the moist filter paper for two to four hours resulting in development of one or more germinating embryos in the one or more sterilized seeds.

The one or more germinating embryos are then isolated by dissecting out the one or more germinating embryos from pericarps of the one or more sterilized seeds by removing testas of the one or more sterilized seeds. The one or more isolated germinating embryos are soaked in 0.05 to 0.15% of mercuric chloride for 2 to 5 minutes. The one or more isolated germinating embryos are then washed two to four times with sterilized distilled water. Subsequently the one or more isolated germinating embryos are immediately cultured in a first modified MS medium. The first modified MS medium contains 2.7 to 3.3% sucrose, 2 to 4 mg/l of Kinetin, 1 to 3 mg/l of BAP and 0.1 to 1.5 mg/l of GA3. The culture may be incubated for a photo-period ranging from 15 to 17 hours with light intensity ranging from 3000 to 5000 lux daily at a temperature ranging from 24 to 26° C. leading to development of one or more shoots from the one or more isolated germinating embryos.

Thereafter, the one or more shoots may be sub-cultured every 15 days by transferring the one or more shoots to a second modified MS medium under controlled aseptic conditions. The second modified MS medium may include a MS medium supplemented with 2.7 to 3.3% sucrose, 2 to 4 mg/l of Kinetin, 1 to 3 mg/l of BAP and 0.1 to 1.5 mg/l of GA3. The sub-cultures may be incubated for a photo-period of 15 to 17 hours with light intensity ranging from 3000 to 5000 lux daily at a temperature ranging from 24 to 26° C. Sub-culturing the one or more shoots in the second modified MS medium under controlled aseptic conditions leads to development of one or more long shoots. The one or more long shoots are morphologically more developed as compared to the one or more shoots.

The one or more long shoots are subsequently transferred to a rooting medium and cultured to obtain one or more rooted plants from the one or more long shoots. The rooting medium may include a MS medium supplemented with IBA. Further, strength of the MS medium present in the rooting medium is half of the strength of the MS medium present in the first modified MS medium.

Thereafter the one or more rooted plants are subjected to an acclimatization process to a natural habitat. The acclimatization process may include transferring the one or more rooted plants to a sterilized 1:1 mixture of vermiculate and coarse sand maintained under humid conditions for two to five days. In addition, air circulation may be permitted gradually for a duration ranging from one to three weeks prior to transferring the one or more rooted plants to a greenhouse. The one or more rooted plants thus obtained may then grow in the green house to develop into one or more matured plants.

### Example

In the following, the method of in vitro germination of Haloxylon persicum in accordance with the invention is explained with reference to an example.

Mature seeds of Haloxylon persicum were obtained from natural population of flowers of Haloxylon persicum in the second week of November. The seeds were obtained by way of crushing and winnowing the flowers and subsequently removing the perianth lobes of the flower using a sterilized scalpel. Thereafter, the seeds were washed with running sterilized water for a period of 30 minutes in a sterile 40 mm test tube covered with a sterile sieve.

The washed seeds are soaked in sterile distilled water for 4 hours in a laminar air flow in presence of light. The soaked seeds were then spread on a moist filter paper to enable the seeds to germinate. The moist filter was covered using petri plates and kept in the laminar airflow for 4 hours in presence of light to allow development of germinating embryos in the seeds. The germinating embryos were then isolated from the seeds by dissecting out the germinating embryos from the pericarp by removing the testa of the seeds. The isolated germinating embryos were then soaked in 0.1% mercuric chloride for a period of 3 minutes. Thereafter, the isolated embryos were washed three times with sterilized distilled water. The isolated germinating embryos were immediately cultured in a modified MS medium with 3.0% sucrose. The MS medium was further supplemented with 3 mg/l of Kinetin, 2 mg/l of BAP and 0.5 mg/l of GA3.

The cultures were then incubated daily under a 16-hour photoperiod with a light intensity of 4000 lux at 24 to 26° C. for 2 weeks to obtain multiple shoots. The multiple shoots were then subjected to sub-culturing every month in a MS medium supplemented with 3.0% sucrose, 3 mg/l of Kinetin, 2 mg/l of BAP and 0.5 mg/l of GA3 to obtain multiple shoots measuring 2 to 3 cm. The multiple shoots were then transferred to a rooting medium to obtain rooted plants. The rooting medium consisted of a half strength MS medium supplemented with 1 mg/l of IBA.

Rooted plants were then transferred to a sterilized mixture of vermiculate and coarse sand for acclimatization to a natural habitat. The ratio of the mixture of vermiculate and coarse sand was 1:1. The rooted plants in the sterilized mixture were then kept under a humid environment for 3 days followed by gradual air circulation for 2 weeks and finally moved to a green house. The survival rate for the seedlings was observed to be about 60 to 80%.

Various embodiments of the invention provide a method for in vitro germination of seeds for Haloxylon persicum. The method provides for adequate moisture required for germination of seeds, maintaining hygiene of the seeds throughout the germination process and adequate acclimatization. The method may be thus utilized for in vitro mass germination of Ghada plant.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for germinating seeds of Haloxylon persicum, the method comprising:
soaking at least one sterilized seed of Haloxylon persicum in sterile water for a predetermined time for developing at least one germinating embryo in the at least one sterilized seed;
isolating the at least one germinating embryo from the at least one sterilized seed; and
growing the at least one isolated germinating embryo in vitro in a culture medium to obtain at least one shoot.

2. The method of claim 1, wherein the soaking further comprises keeping the at least one sterilized seed in contact with moist filter paper under aseptic conditions in presence of light.

3. The method of claim 1, wherein the predetermined time ranges from one to six hours.

4. The method of claim 1, wherein the at least one sterilized seed is obtained by washing at least one seed with sterilized water.

5. The method of claim 1, wherein isolating the at least one germinating embryo comprises dissecting the at least one germinating embryo from a pericarp of the at least one sterilized seed by removing a testa of the at least one sterilized seed.

6. The method of claim 5 further comprising treating the at least one isolated germinating embryo with mercuric chloride.

7. The method of claim 1, wherein the culture medium comprises a first Murashige and Skoog's medium.

8. The method of claim 7, wherein the first Murashige and Skoog's medium is supplemented with at least one of Kinetin, Benzyladenine and Gibberellic acid.

9. The method of claim 8, wherein the at least one isolated germinating embryo is cultured in the first Murashige and Skoog's medium, and incubated under controlled aseptic conditions to obtain at least one shoot.

10. The method of claim 7 further comprising transferring the at least one shoot to a second Murashige and Skoog's medium under aseptic conditions.

11. The method of claim 10 further comprising transferring the at least one shoot from the second Murashige and Skoog's medium to a rooting medium to obtain at least one rooted plant.

12. The method of claim 11, wherein the rooting medium comprises a Murashige and Skoog's medium supplemented with IBA (indole-3-butyric acid), and wherein strength of the Murashige and Skoog's medium present in the rooting medium is less than strength of the first Murashige and Skoog's medium

13. The method of claim 11 further comprising transferring the at least one rooted plant to a sterilized mixture of vermiculate and coarse sand under humid conditions with controlled air circulation for acclimatization of the at least one rooted plant.
